(19) United States
(12) Patent Application Publication
(10) Pub. No.: US 2018/0189753 A1
(43) Pub. Date: Jul. 5, 2018

(54) INFRASTRUCTURE FOR OBLIGATION MANAGEMENT AND VALIDATION

(71) Applicant: Beskatta, LLC, Norfolk, MA (US)

(72) Inventors: Vijay Konda, Sharon, MA (US); Emanuel D. Torti, Norfolk, MA (US); Jay Aaronson, North Easton, MA (US)

(21) Appl. No.: 15/863,135

(22) Filed: Jan. 5, 2018

Related U.S. Application Data
(60) Provisional application No. 62/442,783, filed on Jan. 5, 2017.

(51) Int. Cl. G06Q 20/06; H04L 9/06; H04L 9/14; H04L 9/30; H04L 9/32; H04L 29/06; G06Q 10/08

(52) U.S. Cl. CPC G06Q 20/065; H04L 9/0637; H04L 9/0643; G06Q 10/083; H04L 9/30; H04L 9/3247; H04L 63/0272; H04L 9/14

(57) ABSTRACT

One aspect of the disclosure relates to a system configured for analyzing transactions between two or more parties and creating a digital token (also referred to as a hash), which can include processed and summarized information related to the transaction, to represent the evidence (or other information) associated with the transaction and store the token in a distributed ledger.

### CROSS-REFERENCE TO RELATED APPLICATIONS

This application claims priority to U.S. Provisional Patent Application No. 62/442,783 filed on Jan. 5, 2017, which is herein incorporated by reference in its entirety.

### BACKGROUND

Transactions for goods and services may result in obligations to third parties. For example, a sale of goods from a seller to a buyer may result in taxes (e.g., sales or use taxes) owed to one or more government entities. At least one of the transacting parties is responsible for the reporting and/or payment of any such obligations.

### SUMMARY

This disclosure relates to systems and methods for managing and validating third-party obligations associated with transactions. In some implementations, the transaction is a two-party transaction, e.g., a transaction between a merchant and a buyer. In some implementations, the obligations are recorded in a distributed ledger, e.g., a blockchain ledger. In some implementations, the blockchain ledger is stored in a centralized location such as a data center. In some implementations, the blockchain ledger is stored in a distributed manner that is decentralized and redundant. In some implementations, each block of the blockchain includes confirmation data of previous blocks combined with a proof-of-work element. The blockchain ledger provides a reliable and trustworthy system for recording third-party obligations and tracking payment of the obligations. In some implementations, transaction fees are recorded in the block chain as a fee token that is not only unalterable but also serves an independent forensic function.

The system does not rely on the transacting parties but rather on the transactions themselves. The system collects each transaction and computes an associated obligation for each transaction that is then added to the distributed ledger. In some implementations, the obligation is represented as a token corresponding to the computed fees, referred to herein as a Fees Token.

In some implementations, the system directly sends transaction data from a Merchant computing system to a distributed ledger to process the transactions and create Fees Token.

An authorized third party who is eligible to receive the Fees Tokens can receive the tokens from the distributed ledger. The authorized third party, Merchants, and other interested authorized parties can view the report of all the authorized transactions and Fees Tokens in the distributed ledger. In some implementations, a third party may obtain a report of tokens associated with the transactions. The third party may use the tokens information to collect fees from Merchant or Customer by directly invoicing them. In some implementations, the system collects the payment from the Merchant or Customer accordingly and forwards the payments to the third party based on the Fees Tokens received by the third party.

In some implementations, information published in a blockchain may need to be secured from different parties. For example, a merchant might provide customer information that should only be accessed by authorized parties. If there are multiple third parties, some should be able to access only certain sections of the data published in the Fees Token or originating records. As described herein, in some implementations, data security, and privacy is supported using specialized encryption keys. For example, in some implementations, a multi-access key is used.

One aspect of the present disclosure relates to a system configured to validate transactions, third party obligations and/or blockchain records in a networked environment. The system may include one or more hardware processors configured by machine-readable instructions. The processors may be configured to receive, from a first data processing system, a first set of reference data of an interaction with the first data processing system. The processors may be configured to determine a first hash based on the first set of reference data and a first location on a blockchain. The processors may be configured to post the first hash to the blockchain at the first location. The processors may be configured to receive, from a second data processing system, a second set of reference data. The processors may be configured to determine a second hash based on the second set of reference data and a second location on the blockchain. The processors may be configured to post the second hash to the blockchain at the second location. The processors may be configured to generate a third hash based on a matching of the first hash with the second hash. The processors may be configured to post the third hash to the blockchain at a third location. The processors may be configured to transmit a notification to a third data processing system based on detecting the third hash at the third location.

Another aspect of the present disclosure relates to a method to validate transactions, third party obligations and/or blockchain records in a networked environment. The method may include receiving, from a first data processing system, a first set of reference data of an interaction with the first data processing system. The method may include determining a first hash based on the first set of reference data and a first location on a blockchain. The method may include posting the first hash to the blockchain at the first location. The method may include receiving, from a second data processing system, a second set of reference data. The method may include determining a second hash based on the second set of reference data and a second location on the blockchain. The method may include posting the second hash to the blockchain at the second location. The method may include generating a third hash based on a matching of the first hash with the second hash. The method may include posting the third hash to the blockchain at a third location. The method may include transmitting a notification to a third data processing system based on detecting the third hash at the third location.

An aspect of the present disclosure relates to a non-transient computer-readable storage medium having instructions embodied thereon, the instructions being executable by one or more processors to perform a method to validate blockchain records in a networked environment. The method may include receiving, from a first data processing system, a first set of reference data of an interaction with the first data processing system. The method may include determining a first hash based on the first set of reference data and a first location on a blockchain. The method may include posting the first hash to the blockchain at the first location. The method may include receiving, from a second data processing system, a second set of reference data. The method may include determining a second hash based on the second set of reference data and a second location on the blockchain. The method may include posting the second hash to the blockchain at the second location. The method may include generating a third hash based on a matching of the first hash with the second hash. The method may include posting the third hash to the blockchain at a third location. The method may include transmitting a notification to a third data processing system based on detecting the third hash at the third location.

The foregoing general description and following description of the drawings and detailed description are exemplary and explanatory and are intended to provide further explanation of the invention as claimed.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 illustrates a system configured to validate blockchain records in a networked environment, in accordance with one or more implementations.

FIG. 2 illustrates a method to validate blockchain records in a networked environment, in accordance with one or more implementations.

FIGS. 3A and 3B illustrate a system configured for providing a platform to process third-party requirements, in accordance with one or more implementations.

FIGS. 4A-4Q illustrate workflow between different components of the systems described herein, in accordance with one or more implementations.

FIG. 5A illustrates a process of creating master keys and chain code from a root seed, in accordance with one or more implementations.

FIG. 5B illustrates an example relationship between master seed, parent/child chains, and public addresses, in accordance with one or more implementations.

### DETAILED DESCRIPTION

The systems and methods described herein can enable the transmission and exchange of data in a networked environment and can enable the validation of the transmitted data. The system and methods can validate the data and initiate one-to-many notifications that can notify interested third parties that the data was successfully transferred and validated.

One aspect of the disclosure relates to a system configured for analyzing transactions between two or more parties and creating a digital token (also referred to as a hash), which can include processed and summarized information related to the transaction, to represent the evidence (or other information) associated with the transaction and store the token in a distributed ledger. Another aspect of the disclosure relates to the system configured for calculating the fees/liability associated with the original transaction through an external fees/liability calculation service. In another implementation, the fees/liability calculation can be performed by a “Smart Contract” that executes in the distributed ledger.

Another aspect of the disclosure relates to the system configured for accessing the source of the transactions (such as transaction party computing platform) to get details of the transaction to generate confirmation tokens. The confirmation token can be transferred to the account of the third party authorized by the parties participating in the transaction. The transfer is recorded in the distributed ledger (blockchain).

In some other implementations, the transactions are sent to the distributed ledger directly by one of the parties of the transaction (such as Merchant), and the ledger can create one or more Fees Tokens using a Token Generation Smart Contract. Another aspect of the system relates to the system configured for a third party receiving the tokens assigned to their account (only authorized tokens) from the distributed ledger. The third party can synchronize their account from time to time by connecting to the distributed ledger.

Another implementation within the scope of the disclosure includes allowing the agent access to the transacting key between transacting parties (buyer-seller) or granting the agent a master key thereby enabling agent to directly charge or monitor a transaction. An authorized and interested third party may be able to view the tokens authorized by the Transaction Parties through an interface provided by the system.

Another aspect of the disclosure relates to the system configured for each of the parties participating in the transaction. The transaction participants can view the tokens associated with all the transactions where they are one of the transaction parties.

Another aspect of the system relates to the system configured for a third party to receive payments based on Fees Tokens assigned to their account by one of the agreed transaction participants at an agreed schedule.

Another aspect of the system relates to the interface configured for a third party to send “Receipt Tokens” to the distributed ledger after receiving payments based on Fees Tokens. In another implementation, third party can send Receipt Tokens directly to the distributed ledger.

Another aspect of the system relates to the system configured for Transaction Party to receive “Receipt Tokens” from the distributed ledger directly or via Portal Interface after sending payments based on Fees Tokens.

Another aspect of the system relates to the system configured to store the transaction details in multiple locations or mediums such as a database or distributed ledger or access through an interface.

One aspect of the disclosure relates to a system configured for analyzing transactions between one or more parties (Transacting Parties) in a distributed ledger to determine the fees or interest related to the transaction that needs to be transmitted to one or more third parties via distributed ledger. The interest information or fees is represented as a “token” in the distributed ledger.

In some implementations, the token can be a “Fees Token” for one of the transaction parties posted to the account of a transaction party configured to make payments.

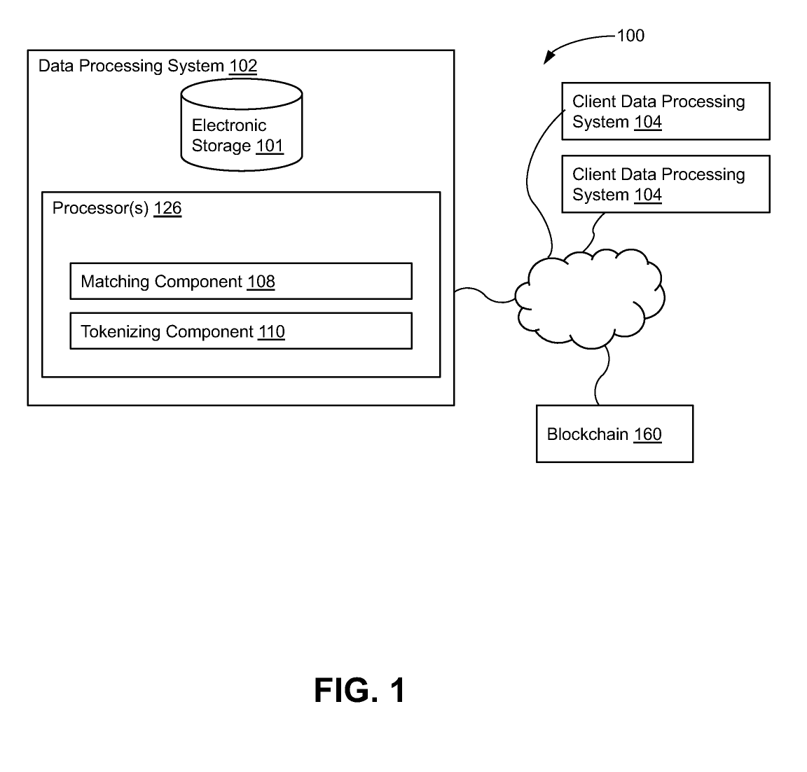

FIG. 1 illustrates a system 100 configured to validate blockchain records in a networked environment. In some implementations, system 100 may include one or more data processing systems 102, such as servers. The data processing system 102 may be configured to communicate with one or more client data processing systems 104 according to a client/server architecture and/or other architectures. The client data processing systems 104 may be configured to communicate with the data processing system 102, other client data processing systems 104, and/or the blockchain 160. In some implementations, the client data processing systems 104 can communicate with the data processing system 102 through an Application Programming Interface (API) provided to the client data processing systems 104 by the data processing system 102.

The data processing system 102 may be configured by machine-readable instructions. Machine-readable instructions may include one or more instruction modules or other components. The instruction modules may include computer program modules. The instruction modules may include one or more of a matching component 108 and a tokenizing component 110.

The data processing system 102 can receive, from a first client data processing system 104, a first set of reference data. The reference data can include information or data of a transaction or communication that occurred with the client data processing system 104. For example, the set of information can include transaction information regarding a purchase, sale, or exchange of goods. The reference data can be transaction information and can include transaction identifiers, customer identifiers, federal identifiers, addresses, account identifiers, items, prices, merchant identifiers, dates, agent identifiers, exception codes, or category codes. The data processing system 102 can also be configured to receive a second set of reference data from a second client data processing system 104. The second client data processing system 104 can be different than the first client data processing system 104. The second client data processing system 104 can generate the second set of reference data responsive to completing a task or function associated with the first set of reference data. For example, the first client data processing system 104 can be a merchant and can transmit the first set of reference data to the data processing system 102 responsive to the completion of a transaction for a good. The second client data processing system 104 can be a shipper and can transmit the second set of reference data to the data processing system 102 responsive to shipping the good. By way of non-limiting example, the sets of reference data may include at least one of an order number, a customer number, a tracking number, a date, an address, an exemption code, or a product code. The data processing system 102 can also receive additional sets of information. For example, the first client data processing system 104 can transmit a second set of information to the data processing system 102 when the first client data processing system 104 receives payment for the good.

The data processing system 102 can also include a tokenizing component 110. The tokenizing component 110 may be configured to determine or generate tokens based on the sets of reference data the data processing system 102 receives. The tokens can be or can include hashes of part or all of the received sets of reference data. The tokenizing component 110 can generate the hashes using a hashing algorithm such as the SHA-256 hashing algorithm. In some implementations, the tokenizing component 110 can generate tokens based on sets of reference data received from different client data processing systems 104. For example, sets of reference data from a merchant and a shipper can be combined to generate a confirmation token that the data processing system 102 can use to indicate and confirm that a good was paid for and shipped. In some implementations, the client data processing systems 104 can provide predetermined data types or data fields (e.g., merchant ID, date, etc.) in the sets of reference data such that the tokenizing component 110 generates the same hash when a first client data processing system 104 provides transaction information and a second client data processing system 104 provides confirmation information. In some implementations, the different client data processing system 104 can provide a plurality of data fields from which the tokenizing component 110 selects the same data fields from each of the different client data processing systems 104 such that if the data in each of the data fields is the same, the hashes generated from the data fields will match.

The tokenizing component 110 can also calculate unique addresses on the blockchain 160 to store the generated tokens. In some implementations, the tokenizing component 110 can generate a hash or token that is a fee token. The fee token can be calculated using a token ID, a transaction ID, fees, payer account, payee account, or dates. The tokenizing component 110 can generate a receipt token or hash that can be calculated using receipt token ID, fee token ID, payment ID, payer account, payee account, or payment date. The unique address can be calculated by using a cryptographic algorithm such as the Elliptic Curve Digital Signature Algorithm (ECDSA).

The data processing system 102 can also include a matching component 108. The matching component 108 can locate and match tokens stored on the blockchain 160. For example, a first token can be stored at a first location when a transaction is initiated. A second token, based on reference data from a shipper, can be stored at a second location on the blockchain 160 responsive to the shipper shipping a good. The matching component 108 can match the token generated when the transaction was initiated with the confirmation token generated by the shipper. In some implementations, the matching component 108 can generate smart contracts that the matching component 108 stores to a public address on the blockchain 160. In some implementations, the smart contract automatically can perform the matching. For example, a smart contract can maintain a map of hash and token address, which can be updated by the smart contract (or matching component 108). When a confirmation token is generated, the smart contract can reference the map of the hash and token address to locate the transaction token. The smart contract can determine if the hash stored in the transaction token and the confirmation token are the same. If the hashes are the same, the smart contract can register the match. For example, the smart contract can generate a third hash and token that is stored to the blockchain 160. In some implementations, the matching component 108 can search for a matching token or hash when the matching component 108 receives confirmation data. For example, a shipper can provide confirmation data to the data processing system 102 via an API call. Responsive to receiving the confirmation data, the matching component 108 can generate the hash for the confirmation token and perform a search (or lookup) for the transaction token. The matching component 108 can then match (or attempt) to match the hash from the transaction token and the confirmation token.

When the matching component 108 locates matching tokens, the matching component 108 can instruct the tokenizing component 110 to generate a new token that indicates that a match was found. The tokenizing component 110 can determine a unique address on the blockchain 160 for the token and post the token to the blockchain 160. The token generated by the tokenizing component 110 in response to the matching component 108 locating matching tokens can be referred to as an obligation token. In some implementations, the matching component 108 can generate a notification that the data processing system 102 transmits to one or more of the client data processing systems 104 in response to generating the obligation token.

In some implementations, the data processing system 102, the client data processing systems 104, and/or the blockchain 160 may be operatively linked via one or more electronic communication links. For example, such electronic communication links may be established, at least in part, via a network such as the Internet and/or other networks.

The client data processing systems 104 may include one or more processors configured to execute computer program modules. The computer program modules may be configured to enable a user associated with the given client data processing system 104 to interface with the data processing system 102 and/or blockchain. By way of non-limiting example, the client data processing systems 104 may include one or more of a desktop computer, a laptop computer, a handheld computer, a tablet computing platform, a NetBook, a smartphone, a gaming console, server, server farm, and/or other computing platforms.

The data processing system 102 can include electronic storage 101, one or more processors 126, and/or other components. The data processing system 102 may include communication lines or ports to enable the exchange of information with a network and/or other computing platforms. The data processing system 102 may include a plurality of hardware, software, and/or firmware components operating together to provide the functionality attributed herein to the data processing system 102. For example, data processing system 102 may be implemented by a cloud of computing platforms operating together.

The electronic storage 101 may include non-transitory storage media that electronically stores information. The electronic storage media of electronic storage 101 may include one or both of system storage that is provided integrally (e.g., substantially non-removable) with the data processing system 102 and/or removable storage that is removably connectable to data processing system 102 via, for example, a port (e.g., a USB port, a firewire port, etc.) or a drive (e.g., a disk drive, etc.) Electronic storage 101 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 101 may include one or more virtual storage resources (e.g., cloud storage, a virtual private network, and/or other virtual storage resources). Electronic storage 101 may store software algorithms, information determined by processors 126, information received from data processing system 102, information received from the client data processing system 104, and/or other information that enables data processing system 102 to function as described herein.

The processors 126 may be configured to provide information processing capabilities in data processing system 102. As such, processors 126 may include one or more of a digital processor, an analog processor, a digital circuit designed to process information, an analog circuit designed to process information, a state machine, and/or other mechanisms for electronically processing information. Although the processor 126 is shown in FIG. 1 as a single entity, the processor 126 may include a plurality of processing units. These processing units may be physically located within the same device, or the processor 126 may represent processing functionality of a plurality of devices operating in coordination. The processor 126 may be configured to execute the matching component 108, the tokenizing component 110, and/or other modules by software; hardware; firmware; some combination of software, hardware, and/or firmware; and/or other mechanisms for configuring processing capabilities on the processor 126.

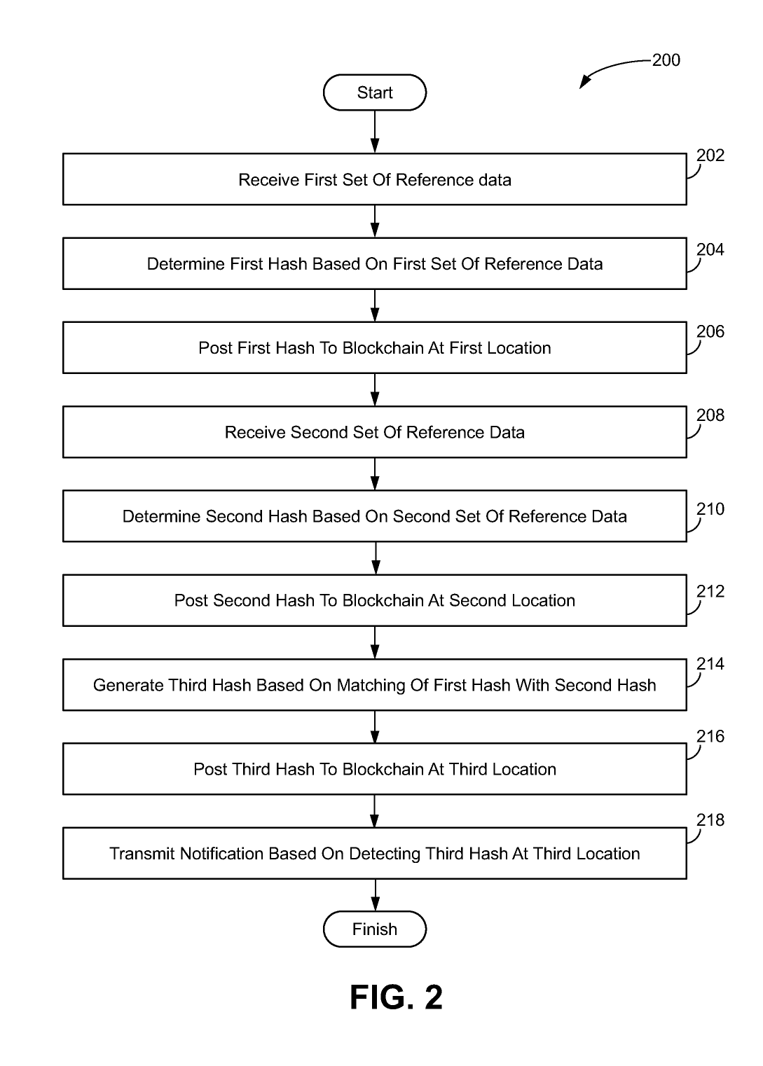

FIG. 2 illustrates a method 200 to validate blockchain records in a networked environment. In some implementations, method 200 may be accomplished with one or more additional operations not described, and/or without one or more of the operations discussed. Additionally, the order in which the operations of method 200 can be performed in an order different than that illustrated in FIG. 2.

In some implementations, method 200 may be implemented in one or more data processing systems 102. The one or more data processing system 102 may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

Referring to FIGS. 1 and 2, among others, the method 200 can include receiving, from a first client data processing system 104, a first set of reference data of an interaction with the first data processing system (step 202). The data processing system 102 can receive the reference data from the client data processing system 104 via a network. The client data processing system 104 can provide the reference data through an API provided by the data processing system 102. The reference data can include information related to a transaction that occurred with or by the first client data processing system 104.

The method 200 can include determining a first hash based on the first set of reference data and a first location on a blockchain (step 204). The tokenizing component 110 can generate a hash or a token based on the received first set of reference data. The tokenizing component 110 can use some or all of the reference data when generating the hash. The tokenizing component 110 can also determine or calculate a location on the blockchain to post the first hash. The tokenizing component 110 can generate the location based on the reference data and/or an encryption key of the first client data processing system 104. The first hash can be referred to as a transaction token. The method 200 can include posting the first hash to the blockchain at the first location (step 206).

The method 200 can include receiving, from a second client data processing system, a second set of reference data (step 208). The second client data processing system 104 can be different than or the same as the first client data processing system 104. For example, in one implementation, the first client data processing system 104 can be associated with a merchant and the second client data processing system 104 can be associated with a shipper. The first client data processing system 104 can generate and transmit the first set of reference data to the data processing system 102 responsive to a transaction for a good and the second client data processing system 104 can generate and transmit the second set of reference data to the data processing system 102 responsive to shipping the good. In some implementations, additional client data processing systems 104 can transmit sets of reference data to the data processing system 102 for inclusion in the second hash. For example, a client data processing system 104 associated with a payment processor and a client data processing system 104 associated with a shipper can each transmit reference data to the data processing system 102 for the generate of a second hash.

The method 200 can include determining a second hash based on the second set of reference data and a second location on the blockchain (step 210). The tokenizing component 110 can generate the second token or hash based on the second set of reference data. The second hash can be referred to as a confirmation token. In some implementations, the tokenizing component 110 can generate the second token based on additional sets of reference data. For example, the second token can be based on reference data from the second client data processing system 104 (e.g., a shipper) and another client data processing system 104 (e.g., a payment processor). When generating the second hash, the tokenizing component 110 can determine which data fields in the reference data were used to generate the first hash. The tokenizing component 110 can use data from the same data fields in the second set of reference data to generate the second hash. For example, if the first hash was generated using a merchant ID, customer ID, and transaction ID, the tokenizing component 110 can select the merchant ID, customer ID, and the transaction ID from the second set of reference data to generate the second hash. The data processing system 102 can post the second token to the blockchain (step 212).

The method 200 can include generating a third hash based on a matching of the first hash with the second hash (step 214). Responsive to receiving the second set of reference data and generating the second hash, tokenizing component 110 can send a notification to the matching component 108 that the matching component 108 should search the blochchain to determine if the blockchain contains a first hash that matches the second hash. The matching component 108 can be or include a smart contract that includes a map of locations where the first hash corresponding to the second hash is stored on the blockchain. The matching component 108 can retrieve the first hash (e.g., the transaction token) and determine if the first hash matches the second hash (e.g., the confirmation token). If during step 204 and step 210, the respective sets of reference data included the same values for the data fields that were incorporated into the first and second hashes, the first and second hashes will match. If the first and the second hash match, the matching component 108 can send a notification to the tokenizing component 110 to generate the third token. The third token can be referred to as an obligation token. In some implementations, responsive to the rules stored in a smart contract, the tokenizing component 110 can generate a plurality of obligation tokens responsive to identifying a match between the first and second hashes. For example, the tokenizing component 110 can generate an obligation token for each of the client data processing systems 104 that are involved in the transaction. The data processing system 102 can post the third token to the blockchain at a third location (step 216).

The method 200 can include transmitting a notification to a third client data processing system based on detecting the third hash at the third location (step 218). In some implementations, responsive to generating the confirmation token, the tokenizing component 110 can generate a notification to one or more client data processing systems 104 indicating to the client data processing systems 104 that the confirmation token was generated and posted to the blockchain. In some implementations, the notification can be the transmission of an obligation token to the public address of a smart wallet associated with the client data processing systems 104 involved in the transaction.

### EXAMPLES

Third parties can have a financial interest in transactions between buyers and sellers. As sales occur, sales agents for companies in a variety of industries earn commissions. Most businesses are required to collect sales tax or pay use tax for third-party States. In the digital advertising space, advertising agencies often earn fees based on the number of clicks on or impressions made of an advertisement.

In some cases there are elements of trust, a burden of proof, reporting requirements, and audit risks. Sales agents trust companies are calculating and paying commissions correctly based on their agreements. States have to trust companies to charge the correct sales taxes and pay them on time. Customers who don't pay sales tax because the seller does not have nexus are on the honor system to pay use tax to the appropriate States. Advertisers put their trust in the agencies they hire to charge only for actual performance.

These arrangements place a burden of proof on the companies responsible for paying third-party fees. They need to have systems in place to record and report on their obligations. The costs are great and since the requirements in these cases are often complicated, the risks for error are high.

Additionally, third parties expecting payment in accordance with their agreements typically have no way to verify the accuracy of the fees they receive. They have no true system of checks and balances. As a result, they are left with few options. They can trust the companies they do business with and accept that the payments received are accurate. They can pay third-party verifiers or exercise their audit rights. In some industries the agents have no choice but to pay for verification. In the case of the States, they have no choice but to audit the sellers. In the end, buyers, sellers, and interested third parties participate in systems that are complicated, costly, and fraught with error and audit risk.

There are typically two ways a business may structure its agent relationships. The first is the reseller model. In this case, the agent can purchase product directly from the seller at a discount. It would then resell those products at a higher price and keep the margin. This arrangement is clean. The third party reseller fees are determined by the agents themselves. No external verification is necessary. No additional reporting requirements are placed on the merchant.

In the second model, the agent can refer a buyer to the seller. When product is sold the agent can earn a commission based on a predetermined formula. Under this situation, the elements of trust, burden of proof, reporting requirements, and audit risks come into play.

A sales representative or “affiliate” under the second model may have either a direct or indirect relationship with the merchant. In this case the affiliate can have a direct relationship with the merchant who can report sales generated, then calculate and pay commissions. If the affiliate has an indirect relationship, an intermediary can keep track of performance, pay for results and then report to both the sales affiliate and the merchant. Affiliate marketing is a type of performance-based marketing in which a business rewards one or more affiliates for each visitor or customer brought by the affiliate's own marketing efforts. The industry can have four core players: the merchant (also known as “retailer” or “brand”), the network (that contains offers for the affiliate to choose from and also takes care of the payments), the publisher (also known as “the affiliate”), and the customer. The market has grown in complexity, resulting in the emergence of a secondary tier of players, including affiliate management agencies, super-affiliates, and specialized third-party vendors.

Some merchants run their own (in-house) affiliate programs using dedicated software, while others use third-party intermediaries to track traffic or sales that are referred from affiliates. There are two different types of affiliate management methods used by merchants: standalone software or hosted services, typically called affiliate networks. Payouts to affiliates or publishers can be made by the networks on behalf of the merchant, by the network, consolidated across all merchants where the publisher has a relationship with and earned commissions or directly by the merchant itself.

These “affiliate networks” track internet traffic, clicks, and impressions as a way of compensating the sales agent. This can aid rogue affiliates, who use spamming, trademark infringement, false advertising, cookie stuffing, typo squatting, and other unethical methods that have given affiliate marketing a negative reputation. Some merchants are using outsourced (affiliate) program management (OPM) companies, which are themselves often run by affiliate managers and network program managers. OPM companies perform affiliate program management for the merchants as a service, similar to the role an advertising agency serves in offline marketing. Cookie stuffing involves placing an affiliate tracking cookie on a website visitor's computer without their knowledge, which can then generate revenue for the person doing the cookie stuffing. This not only generates fraudulent affiliate sales, but also has the potential to overwrite other affiliates' cookies, essentially stealing their legitimately earned commissions.

If the merchant uses a standalone software product, sales are directly attributable to the affiliate agent, but there is still an element of trust required. They have to rely on the merchant's honesty. With the hosted service model, commissions are based on clicks, impressions or other sales formulas.

Companies hire advertising agencies to write ad copy, produce graphic designs, and layout ad campaigns. In addition, these agencies are compensated for managing ads placed on digital marketing networks. They typically receive a markup on the cost of program transactions, which are generally based on actions taken by a prospect (signing up or registering, clicking on an ad, etc.) or the number of impressions displayed.

The process for delivering ads on publishers' websites is complicated, and there are several players involved. Media suppliers provide a marketplace and platform to match advertisers with the ad space inventory of publishers. The advertising agencies of record may have parent companies, trading desks, and sister companies that have relationships with media suppliers. All of the layers and steps in the process and the number of players involved force these networks to be inefficient and are fertile ground for fees on top of fees.

In addition, because these networks are so complicated, the advertisers are often unaware of the details and actual costs involved in delivering their ads. The invoices they receive are often summarized into gross program fees. The details of transaction costs are seldom know to the advertiser. This creates an air of mistrust which leads to the potential for audit.

Almost every transaction between a buyer and seller has sales or use tax consequences. As the transactions occur, the seller is required to collect sales tax on behalf of the State where the customer resides. 45 out of the 50 States charge a sales tax. These third-party States, with their financial interest in the transactions, place the burden of collection, payment, and reporting on the merchants. The requirements, for the most part, fall on these corporations if they have nexus in the State where the customer uses the purchased goods.

Some sellers use either their internal accounting systems or an outside service provider to calculate, pay, and report on sales tax transactions. In addition, if the customer is exempt from a States sales tax, the seller is required to maintain a copy if their Exempt Certificate on file.

If the seller does not have nexus in a particular State, then it is the customer's obligation to pay and report on the use tax due. It can be cost prohibitive and near impossible to get consumers to comply with use tax regulations. As a result, the States are constantly looking for ways to add reasons why merchants have nexus.

The systems and methods disclosed herein solve the above described problems of transparency, burden of proof, documentation, reporting, high administrative costs and audit risk for processing third party transaction fees. The described systems can be integrated with current merchant accounting systems for collecting transaction data and calculating third-party fees based on smart contracts and processing payments securely and with strict confidentiality.

For example, the system can enable agents to receive reports of sales directly attributable to their efforts; receive reports of sales and commissions directly attributable to sales agents; calculate commissions based on agreed-upon rules between the merchant and sales agent; automatically pay commissions based on terms outlined in one or more smart contracts; reduce administrative and reporting burdens; and perform audits. The system can enable publishers and advertising agencies to receive reports of sales directly attributable to their efforts; enable advertisers to receive reports of sales and commissions directly attributable to publishers and advertising agents; calculate commissions based on agreed-upon rules between the advertisers, publishers and advertising agency; reduce the administrative burden of reporting and calculating fees; and perform audits. The system can enable States and other governments to collect sales tax directly from the consumer, yielding greater compliance; collect most of the now uncollected use tax; simplified tax remittances; simplified reporting; provide privacy in transactions; reduce reporting and collecting burdens; provide consumers with exposure to their annual sales tax expenditure; and perform audits.

The blockchain can also be referred to as a distributed ledger, a public ledger, a transaction database, and/or by other terms, to create a publicly verifiable record of digital transactions. Digital transactions may include cryptocurrency transactions such as Bitcoin, Litecoin, Namecoin, Ethereum, and/or other similar digital transactions.

Cryptocurrency tokens are entries on a ledger (e.g., a blockchain). An entity (such as an individual or a business) owns these tokens or hashes because they have or control a key that enables them to create a new entry on the ledger, e.g., for re-assigning the ownership to someone else.

The tokens are not necessarily stored on the entity's computer. The entity generally only needs to store the keys that let the entity reassign the quantity. These “tokens” are specific amounts of digital resources which an entity controls and can reassign control of to someone else. There can be two types of tokens: “intrinsic” (also referred to as “native” or “built-in” tokens) and “asset-backed” tokens issued by a party onto a blockchain for later redemption.

Intrinsic tokens are made-up resources that have some utility. These “coins” or “tokens” form part of the core of the blockchains, and the blockchains would not run without them. Intrinsic tokens can provide block validation incentives (“miner rewards”) and transaction spam prevention. For example, if all transactions cost some token, it limits the ability to spam. In some implementations, it takes an investment of time or resources to obtain an intrinsic token. For example, an intrinsic token may require computation of some value. In some implementations, intrinsic tokens are granted in exchange for computation of a new block on the chain.

Asset-backed tokens are the digital equivalent of a real asset. They are claims on an underlying asset (e.g., gold), that can be claimed from a specific issuer (e.g., a goldsmith). The transactions as tokens get passed between people and recorded on the blockchains. To claim the underlying asset, a claimant sends his or her token to the issuer, and the issuer responds by providing the underlying asset.

There can be a blockchain or distributed ledger which lacks an intrinsic token; however, asset-backed tokens are likely to still be used. The term “tokenless” refers to a lack of intrinsic token and not a lack of asset-backed token.

A cryptocurrency digital wallet is a secure digital wallet used to store, send, and receive digital currency like Bitcoin or tokens created by blockchain technologies. Most coins have an official wallet or a few officially recommended third-party wallets. In most implementations, a cryptocurrency wallet is used to manage access to a cryptocurrency.

Cryptocurrency itself is not actually “stored” in a wallet. Instead, a private key (secure digital code known only to an owner and the owner's wallet) is stored that shows ownership of a public key (a public digital code connected to a certain amount of currency). So a wallet stores private and public keys, enabling the owner to send and receive coins, and also acts as an owner-specific ledger of transactions.

There are a number of different types of wallets that can be used, including online, offline, mobile, hardware, desktop, and paper. Each wallet “type” refers to the type of medium the wallet is stored on and whether or not the data is stored online. Some wallets offer more than one method of accessing the wallet—for instance, Bitcoin Wallet is a desktop application and a mobile app. A desktop wallet is typically an app that connects directly to a coin's client and runs on a desktop computing device. A mobile wallet is a wallet that is run from a smartphone app. An online wallet is a web-based wallet. A user doesn't download an app, but rather data is hosted on a real or virtual server. Some online wallets are hybrid wallets allowing encryption of private data before being sent to the online server. A hardware wallet is a dedicated hardware device that holds cryptocurrency and keeps it secure, e.g., in an embedded memory circuit. Hardware wallets include, for example, USB devices. Hardware wallets can go online to make transactions and get data and then can be taken offline for transportation and security. Paper wallets are printed materials. In some paper wallets, a user prints out a QR code for both a public and a private key. This allows both spending and receiving digital currency using a paper wallet while avoiding storing digital data online.

Smart contracts are computer protocols that facilitate, verify, or enforce the negotiation or performance of a contract or that make a contractual clause unnecessary. Smart contracts usually also have a user interface and often emulate the logic of contractual clauses. Proponents of smart contracts claim that many kinds of contractual clauses may thus be made partially or fully self-executing, self-enforcing, or both. Smart contracts aim to provide security superior to traditional contract law and to reduce other transaction costs associated with contracting.

In the context of blockchains (distributed ledger) and cryptocurrencies, smart contracts can include pre-written logic (computer code); be stored and replicated on a distributed storage platform (e.g., a blockchain); can be executed by a network of computers (usually the same ones running the blockchain); and can result in ledger updates (cryptocurrency payments, etc.) If blockchains provide distributed, trustworthy storage, then smart contracts provide distributed, trustworthy calculations.

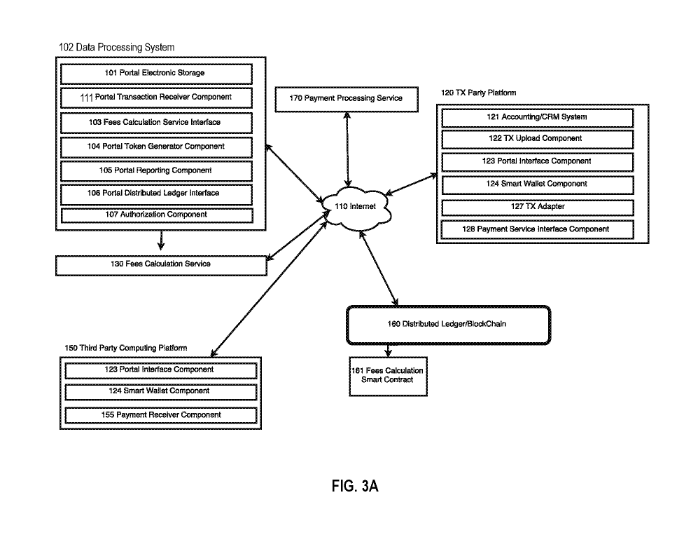

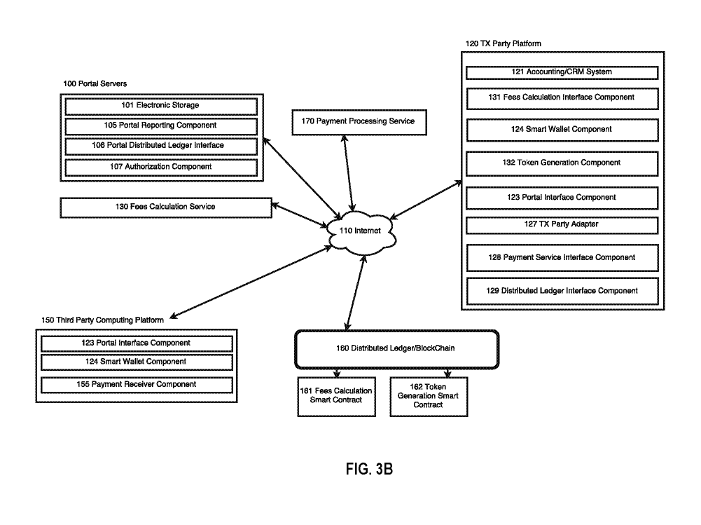

FIGS. 3A and 3B illustrate a system configured for providing a platform to process third-party fees associated with a transaction using a centralized data processing system 102, TX party platform 120 (an example client data processing system 104), third-party computing platform 150 (an example client data processing system 104), Payment Processing service 170 and distributed ledger 160. One or more of the components of the system illustrated in FIGS. 3A and 3B can be components of the system illustrated in FIG. 1. For example, the data processing system 102 illustrated in FIGS. 3A and 3B can perform and execute any of the components or functions described in relation to the data processing system 102 illustrated in FIG. 1. The data processing system 102 illustrated in FIG. 1 can perform and execute any of the components or functions described in relation to the data processing system 102 illustrated in FIGS. 3A and 3B.

The data processing system 102 can collect and store transaction data. The data processing system 102 can interface, via the fees calculation service interface, with an external fees calculation service 130 to compute fees associated with a transaction. The data processing system 102 can generate, based on the computed fees, “Fees Tokens.” The portal reporting component 105 can generate and provide reports to the client data processing systems 104. The tokenizing component 110 can generate tokens and the portal distributed ledge interface can post the tokens to the blockchain 160.

The data processing system 102 can include electronic storage 101. The data processing system 102 can store in the electronic storage 101 data related to origination transactions. The data processing system 102 can store information related to accounts of each of the Merchants, Customers and third-party agents. The data processing system 102 can include a Portal Transaction Receiver Component 111 that can receive sets of reference data from the client data processing systems 104. The data processing system 102 can include a fees calculation service interface 103. The fees calculation service interface 103 can communicates with an external fees calculation service to compute fees associated with a transaction and receive the results of the computation.

The data processing system 102 can include a portal reporting component 105. The portal reporting component 105 can generate report related to different aspects of transactions associated with a Merchant, Customer, or third party for a different time period based on user request and displays via a Graphical User Interface. The data processing system 102 can include a portal distributed ledger interface 106. The portal distributed ledger interface 106 can communicate with the distributed ledger to post transactions or tokens or interact with smart contracts residing in a distributed ledger. The data processing system 102 can include an authorization component 107. The authorization component 107 can provide an interface for users to authorize/restrict other users' ability to access or modify information associated with their accounts.

The system 100 can include a transaction party (TX) computing platform, which can be an example of a client data processing system 104. The transaction party computing platform can use one or more components of the system in order to communicate with data processing system 102 and the distributed ledger 160. For example, the data processing system 102 can provide an API that the transaction party computing platform can use to post transactions and tokens to the distributed ledger 160. The transaction party computing platform can interface with the data processing system 102 to receive reports, collect tokens from distributed ledger 160, and make payments associated with fees. The transaction party computing platform can include an accounting/CRM System 121. The accounting/CRM system 121 can record transactions and may store third-party relationship information. The transaction party computing platform can include a TX upload component 122. The Transaction Upload Component 122 can interface with Merchant Account or CRM system 121 to upload transactions to the data processing system 102 using the portal interface component 123.

The transaction party computing platform can include a portal interface component 123. The portal interface component 123 can enable users to log into the data processing system 102 and create and view reports of their transactions or authorize/restrict access of other users. The transaction party computing platform can include a smart wallet component 124. The smart wallet component 124 can synchronize with the distributed ledger 160 and stores the Fees Token or other tokens associates with that account and can store payment information such as bank account or credit card to make payments to third parties. The transaction party computing platform can include a TX adapter 127. The TX adapter 127 can provide access for the data processing system 102 to interface with accounting/CRM 121 system to extract transaction information (which can also be referred to as reference data). The transaction party computing platform can include a payment service interface component 128. The payment service interface component 128 can communicate with an external Payment Gateway service to make payments to the third party.

The system can include a fees calculation service 130. The fees calculation service 130 can be an external service utilized by data processing system 102 or client data processing systems 104 (e.g., a Merchant) to calculate fees associated with a transaction.

The system can also include a third-party computing platform 150, which can be another example of a client data processing system 104. The third-party computing platform 150 can use one or more components of the system in order to communicate with the data processing system 102 or other client data processing systems 104 to upload transactions; receive reports and collect tokens from the distributed ledger 160; and receive payments associated with fees. The third-party computing platform 150 can include a portal interface component 123. The portal interface component 123 can enable users to log into data processing system 102 and create or view reports of transactions or authorize or restrict access of other systems or users. The third-party computing platform 150 can include smart wallet component 124. The smart wallet component 124 can synchronize with distributed ledger 160 and can store the Fees/Receipt Tokens or other tokens associates with the account. The electronic storage 101 can be a desktop or web browser based application and can be configured to communicate with other computing platforms such as distributed ledger 160 or accounting/CRM platforms 121. The third-party computing platform 150 can include a payment receiver interface component 155. The payment receiver interface component 155 can communicate with an external Payment Gateway service to receive payments.

The system 100 can also include the blockchain 160 (also referred to as a distributed ledger 160). The blockchain 160 can include one or more nodes that record and maintain the information. One or more smart contracts 161 can reside on the blockchain 160 to calculate fees. A token generation smart contract 161 can also reside on the distributed ledger 160 to generate tokens based on a transaction sent to the distributed ledger. For example, the smart contracts 161 can perform one or more of the functions of the tokenizing component 110.

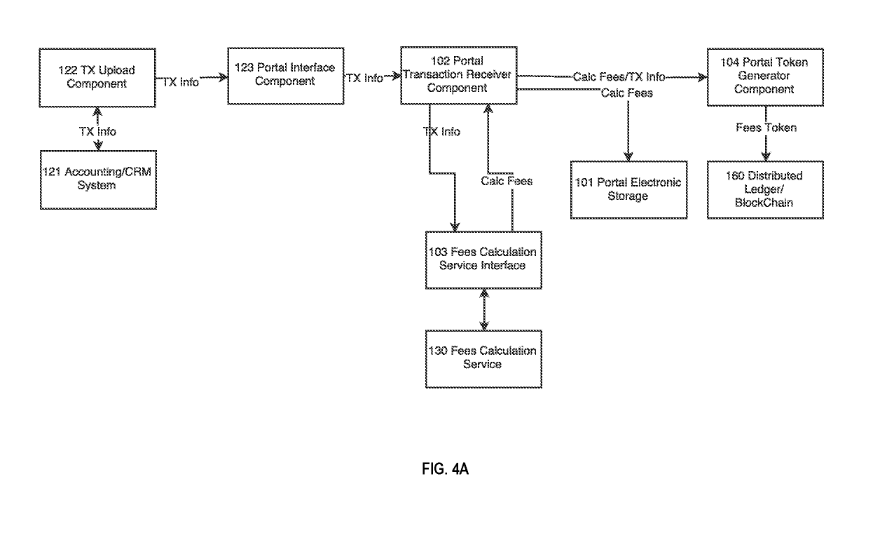

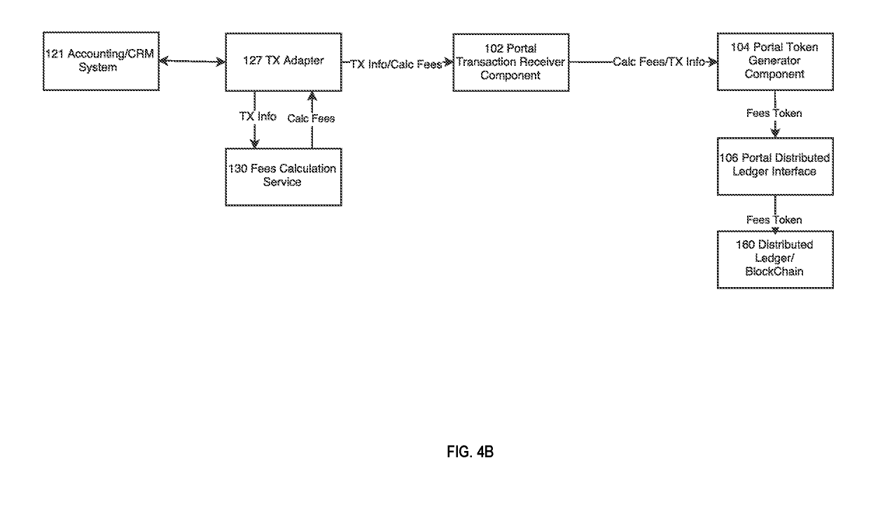

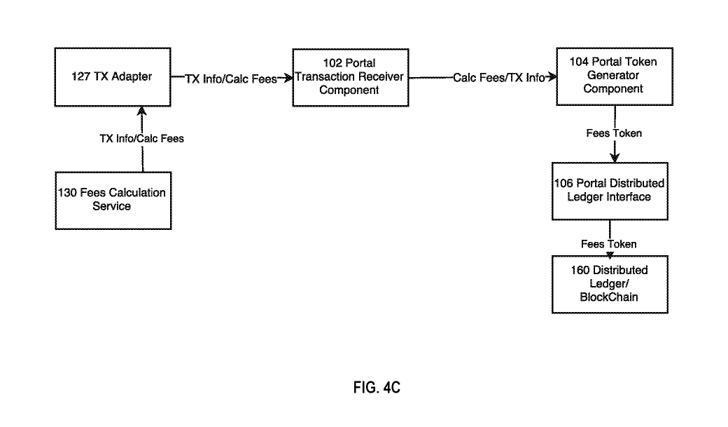

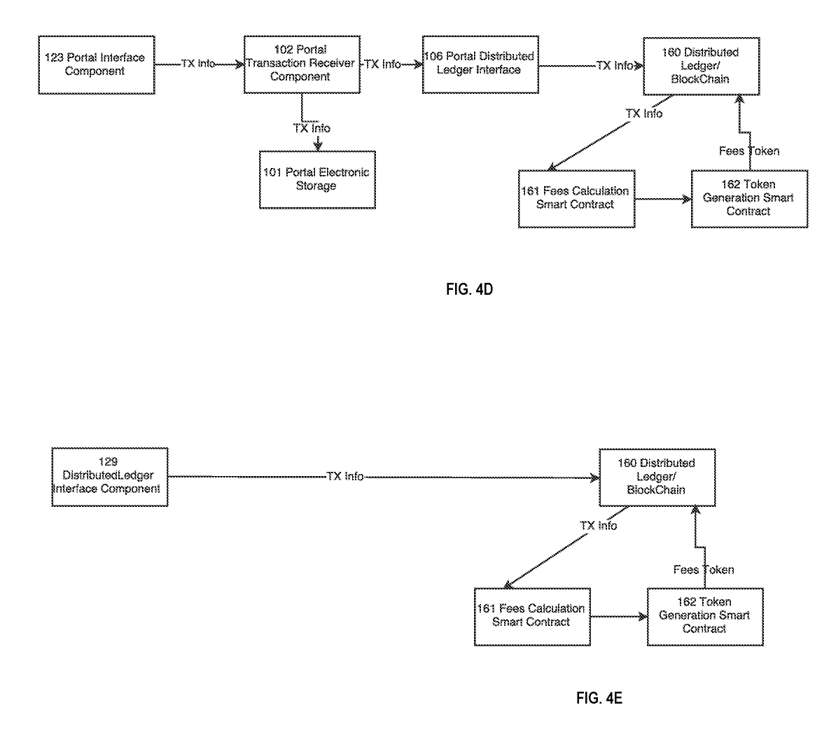

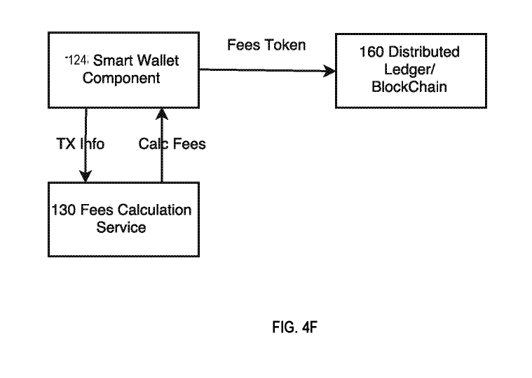

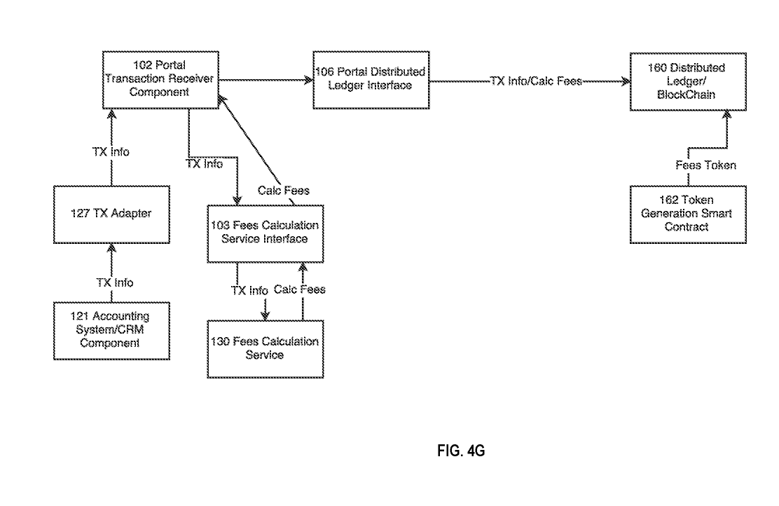

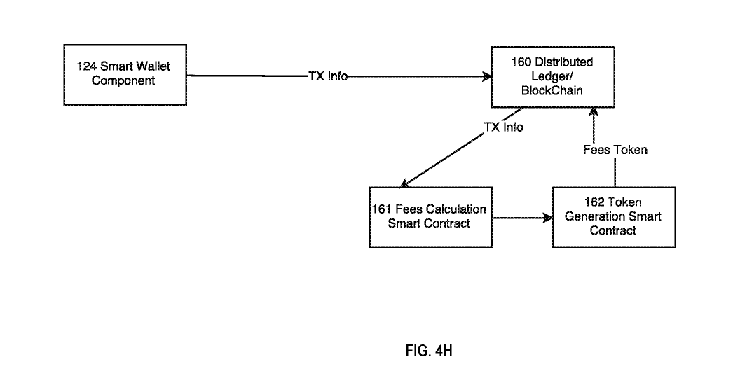

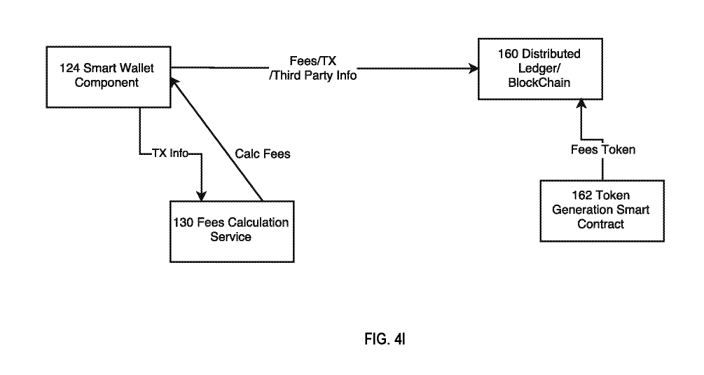

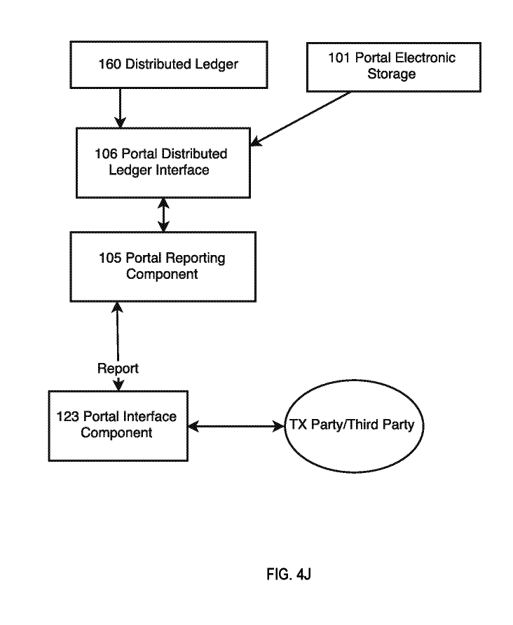

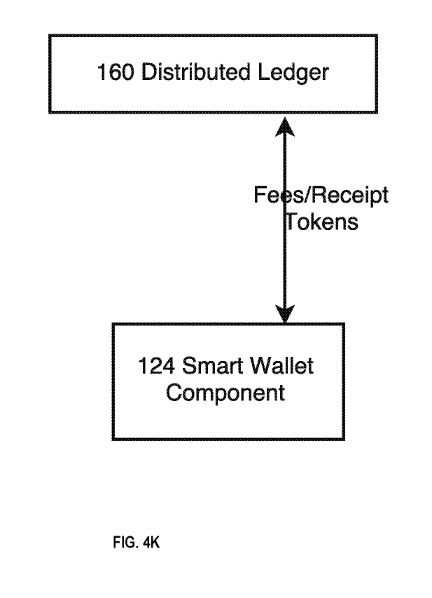

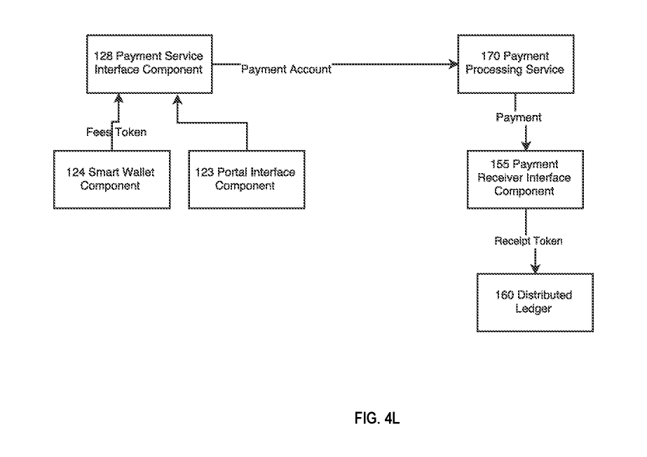

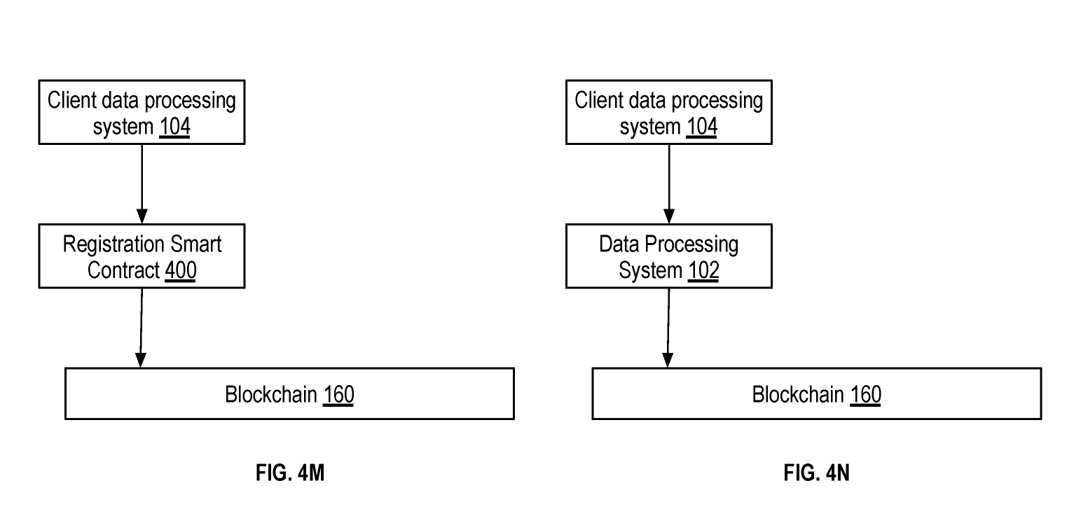

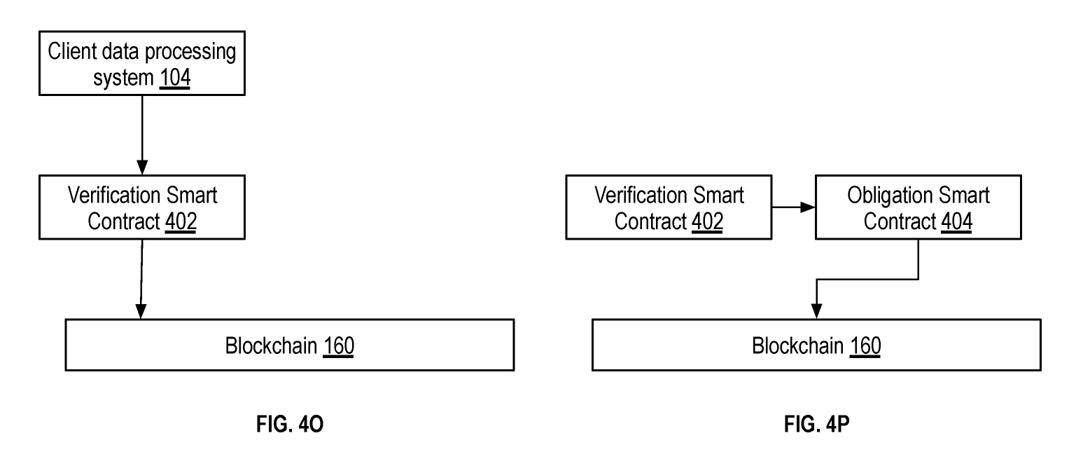

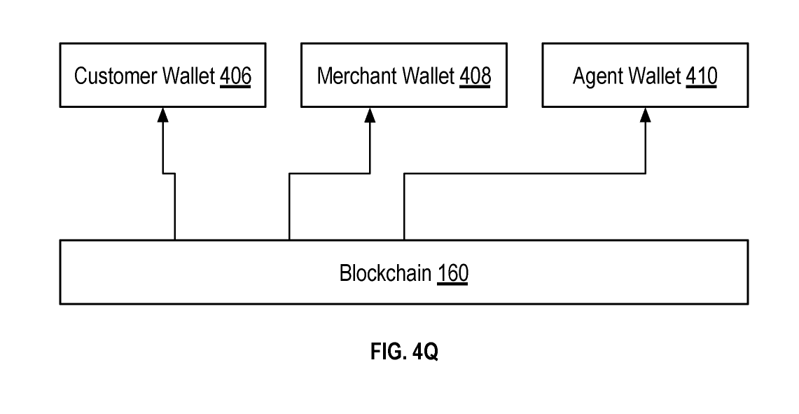

FIGS. 4A-4Q illustrate various aspects of workflow between different components of the system 100. FIG. 4A illustrates a workflow of a transaction party computing platform 120 to upload the transactions to data processing system 102. The TX upload component 122 can use different protocols and APIs to extract transaction information from the accounting/CRM system 121 and can use the portal interface component 123 to upload the transaction to data processing system 102. The Portal Transaction Receiver Component 111 executing on the data processing system 102 can receive the transaction information (also referred to as reference data) and communicates with the fees calculation service 130 to calculate fees associated with the transaction via fees calculation service interface 103. The fees calculation service 130 can be an external service configured to calculate fees associated with a transaction to a third party based on rules and parameters specific to a business area. The data processing system 102 can forward the transaction information and calculated fee to the tokenizing component 110 to create a Fees Token. The Fees Token is then sent to the blockchain 160.

FIG. 4B illustrates a workflow where the TX Adapter component 127 extracts the transaction information (e.g., reference data) from an external accounting/CRM System 121 and uses fees calculation service 130 to calculate fees associated with the transaction and communicates with the data processing system 102 to send that information to tokenizing component 110 to create a Fees Token that is sent to the distributed blockchain 160 using the portal distributed ledger interface 106.

FIG. 4C illustrates a workflow where the TX Adapter component 127 extracts the transaction information and calculates fees from an external fees calculation service 130 and communicates with data processing system 102 to send that information to the tokenizing component 110 to create a Fees Token that is sent to the blockchain 160 using the portal distributed ledger interface 106.

FIG. 4D illustrates a workflow where the portal transaction receiver component 111 receives TX information from portal interface component 123 and communicates with the blockchain 160 using the portal distributed ledger interface 106 to send the TX information. The fees calculation smart contract 161 can be configured to monitor the distributed ledger and calculate the fees associated with the transaction. The token generation smart contract 162 can use the information generated by the fees calculation smart contract 161 to create the Fees Token and store the token in distributed ledger 160.

FIG. 4E illustrates a workflow where the Distributed Ledger Interface component 129 forwards the TX information to the distributed ledger 160, which is processed by the fees calculation smart contract 161 to calculate the fees associated with the transaction. The token generation smart contract 162 can use the information generated by the fees calculation smart contract 161 to create the Fees Token and store the token in the distributed ledger 160.

FIG. 4F illustrates a workflow where the smart wallet component 124 on a transaction party computing platform 120 extracts information from the accounting/CRM system 121 and calculates the fees using the fees calculation service 130 and creates a Fees Token and sends it to distributed ledger 160.

FIG. 4G illustrates a workflow where the Portal Transaction Receiver Component receives 102 receives TX information from the TX Adapter 127, which extracts the information from the accounting/CRM system 121. The Portal Transaction Receiver Component 111 communicates with the fees calculation service 130 via the fees calculation service interface 103. The Fee calculation service 130 calculates the fees associated with the transaction and forwards the TX information and calculated fees to the distributed ledger 160 via the portal distributed ledger interface 106. The token generation smart contract 162 can use the information to create Fees Token and store the tokens in the distributed ledger 160.

FIG. 4H illustrates a workflow where the smart wallet component 124 on a transaction party computing platform 120 extracts information from the accounting/CRM system 121 and forwards the TX information to distributed ledger 160. The information can be processed by the fees calculation smart contract 161 to calculate the fees for the transaction which can be used by token generation smart contract 162 to create Fees Token and store the tokens in the distributed ledger 160.

FIG. 4I illustrates a workflow where the smart wallet component 124 on a transaction party computing platform 120 extracts information from accounting/CRM system 121 and use an external fees calculation service 130 to calculate the fees associated with the transaction. The smart wallet component 124 forwards the TX information and Calculated Fees to the distributed ledger 160. The token generation smart contract 162 can create Fees Tokens and store the tokens on the distributed ledger 160.

FIG. 4J illustrates a workflow where the system 100 provides reports for Transaction Parties and Third Parties based on their authorizations. The workflow can include the third party (TX Party) logging into the data processing system 102 via a web browser. The web browser can use the portal interface component 123 to communicate with the Portal Reporting Component 105. The portal reporting component 105 can access the distributed ledger 160 and/or Portal Electronic Storage 101 to collect data to present in formatted reports. The reports can include the transaction information, tokens generated, and payments made or received in a given range. The reports can be generated weekly, monthly, or annually.

FIG. 4K illustrates a workflow to provide reports for Transaction Parties and third parties based on their authorizations using a smart wallet component 124. The smart wallet component 124 can be a desktop or web browser based application that is customized to display different aspects of the transactions and Fees Token to different parties based on their authorizations and configuration. The smart wallet component 124 can communicate with the distributed ledger 160 and can download the tokens associated with the accounts of a customer and synchronize the tokens. A user can view reports of the tokens (e.g., Fees Tokens and Payment Tokens) associated with their accounts.

FIG. 4L illustrates a workflow to provide payments. A user can log into browser based web application and use portal interface component 123 or use the smart wallet component 124 to view a report of payments owed to the third party based on Fees Tokens associated with the account. The user can configure their payment methods and use the Payment Service Interface Component 128 to communicate with an external Payment Processing Service 170 to send the payments which can be processed or reported to the payment receiver interface component 155 of the third-party computing platform which can send Receipt Tokens to the distributed ledger 160 to indicate that a payment has been received. The smart wallet component 124 and/or data processing system 102 can synchronize these tokens periodically based on a configuration to view reports of their payments or liabilities and also can upload the information into their accounting/CRM system 121.

FIG. 4M illustrates a workflow to register obligations. A client data processing system 104, such as a merchant, can register obligations on the blockchain 160. The client data processing system 104 can define rules for the generation of obligations (e.g., commission rates). The client data processing system 104 can register the rules and other metadata on the blockchain 160 through a registration smart contract 400.

FIG. 4N illustrates a workflow to register transaction information with the blockchain 160. A client data processing system 104, such as a merchant subscribing to the system 100, can provide transaction information to the blockchain 160. The client data processing system 104 can provide the transaction information (e.g., sets of reference data) to the blockchain 160 through an API of the data processing system 102. In some implementations, the client data processing system 104 can provide the transaction information to the blockchain 160 directly. The transaction information can be posted to the blockchain 160 as a hash. For example, the tokenizing component 108 can select data fields from the transaction information and generate a hash that is posted to the blockchain 160.

FIG. 4O illustrates a workflow to register transaction information on the blockchain 160. To register transaction information, client data processing system 104, such as those of third parties, can transmit transaction information to the blockchain 160. For example, a shipping company, responsive to shipping a good, can transmit shipping information (and other reference information) to a verification smart contract 402. The verification smart contract 402 (which can be a component of or generated by the tokenizing component 110) can generate a confirmation token that is stored to the blockchain 160. As illustrated in FIG. 4P, the verification smart contract 402 can transmit a notification to the obligation smart contract 404 that includes an identification of the confirmation token that was added to the blockchain 160. Responsive to receiving the notification, the obligation smart contract 404 can reference a lookup table to determine the address of a transaction token that corresponds to the confirmation token. The obligation smart contract 404 can determine if the hash of the transaction token matches the hash of the confirmation token.

In some implementations, the obligation smart contract 404 can, responsive to matching the hash of the confirmation and transaction tokens, generate obligation tokens. The obligation smart contract 404 can generate different obligation tokens for different parties (e.g., client data processing systems 104) involved in the transaction. For example, a tax obligation token and a commission obligation token can be generated. The obligation tokens can be generated based on the rules and metadata included in the registration smart contract 400.

FIG. 4Q illustrates a workflow to sync digital wallets. The digital wallets associated with the different client data processing systems 104 that are involved in the transaction can sync with the blockchain 160 to sync their respective balance of tokens. For example, the customer wallet 406, the merchant wallet 408 and the agent wallet 410 can each sync with the blockchain 160. The digital wallets can sync with the blockchain 160 using a public key address associated with each of the digital wallets.

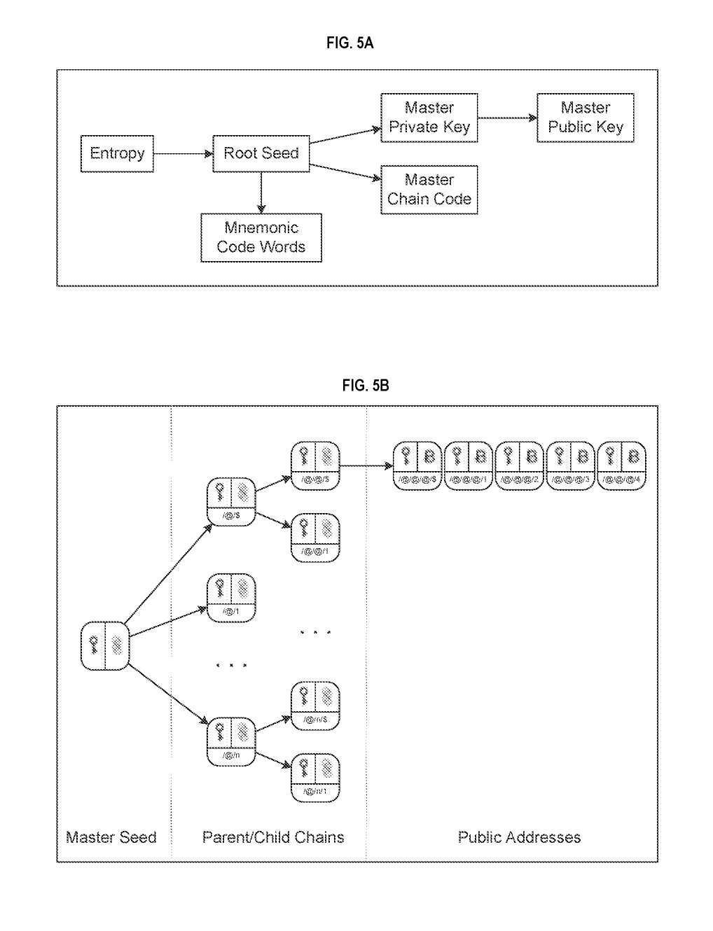

FIG. 5A illustrates a process of creating master keys and chain code from a root seed. In some implementations, a root seed is generated from a source of randomness (entropy) such as a pseudo-random number generator or an environmental input sensor. In some implementations, the root seed is a number up to 64 bytes long. In some implementations, to make the root seed easier to save and recover, a phrase consisting of a list of mnemonic code words is rendered.

The root seed is used to generate a master private key and a master chain code. The master private key is used to generate a master public key, as with normal Bitcoin private keys and public keys. These keys are then used to generate additional child keys in a tree-like structure.

As illustrated in FIG. 5A, using a child key derivation function, child keys can be generated from the master or parent keys. An index is then combined with the keys and the chain code to generate and organize parent/child relationships. In some implementations, from each parent, two billion child keys can be created, and from each child's private key, the public key and public address can be created.

In some implementations, in addition to generating a private key and a public address, each child can be used as a parent to generate its own list of child keys. This allows the organization of the derived keys in a tree-like structure. Hierarchically, an unlimited amount of keys can be created in this way. The entire tree of keys can be backed up and restored simply by using the passphrase.

FIG. 5B illustrates an example relationship between master seed, parent/child chains, and public addresses.

The data processing system 102 can generate keys whenever a new third party is registered. The third party can have access to their own private keys but public keys are made available to all parties. The Token Generation component can encrypt sections of data published on the blockchain by using public keys of the third party only if the Merchant wants to authorize access to this section by the third party. The third party can decrypt the specific sections of data using private keys corresponding to the node or higher level but cannot see sections encrypted using other keys even at the sibling level. This optimizes the performance of the system for processing tokens or generating reports since the third party does not need to process data that is not authorized for this third party. This can also reduce data to be maintained in the memory or buffer of the computing system while processing the blockchain records.

In some implementations, a hierarchical key structure is created that uses the keys at different level nodes to encrypt information. The third party can look at the sections of the data if they have the private key at that node level or higher parent node and cannot access data encrypted with keys by the sibling level node keys.

Exempt Coins: One of the third parties might provide exemptions from some transaction involving some customers. The third party can create an Exemption Token, which is then used by the Token Generation Component to avoid generating Fees Tokens. For example, suppose a Customer is a reseller of certain products of a merchant. A blockchain Smart Contract generates an Exempt Coin which can be used by Merchant to exempt the corresponding transactions from sales tax. As another example, suppose a Customer registers as non-profit. The States uses an Exemption Token component to send an Exemption Token to the blockchain for the non-profit customer. Then all corresponding transactions can be exempt from sales tax.

In some implementations, summary reports of the transactions of a merchant can be used to calculate obligations owed by the merchant, obligations owed by the customer, obligations exempted by the merchant, etc., and compare them to the actual transactions in the blockchain. By automatically generating secondary and alternative reports, the Portal Server provides a Self-Audit Component which can be used by third party.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

References to “or” may be construed as inclusive so that any terms described using “or” may indicate any of a single, more than one, and all of the described terms. The labels “first,” “second,” “third,” and so forth are not necessarily meant to indicate an ordering and are generally used merely to distinguish between like or similar items or elements.

Thus, particular implementations of the subject matter have been described. Other implementations are within the scope of the disclosure. In some cases, the actions recited can be performed in a different order and still achieve desirable results. In addition, the processes depicted in the accompanying figures do not necessarily require the particular order shown, or sequential order, to achieve desirable results. In certain implementations, multitasking or parallel processing may be used.

What is claimed is:

1. A system configured to validate blockchain records in a networked environment, the system comprising one or more hardware processors configured by machine-readable instructions to:
receive, from a first data processing system, a first set of reference data of an interaction with the first data processing system;
determine a first hash based on the first set of reference data and a first location on a blockchain;
post the first hash to the blockchain at the first location;
receive, from a second data processing system, a second set of reference data;
determine a second hash based on the second set of reference data and a second location on the blockchain;
post the second hash to the blockchain at the second location;
generate a third hash based on a matching of the first hash with the second hash;
post the third hash to the blockchain at a third location; and
transmit a notification to a third data processing system based on detecting the third hash at the third location.

2. The system of claim 1, wherein the first set of reference data and the second set of reference data comprises at least one of an order number, a customer number, a tracking number, a date, an address, an exemption code, or a product code.

3. The system of claim 1, wherein the one or more hardware processors are further configured by machine-readable instructions to:
receive, from a third data processing system, a third set of reference data; and
determine the second hash based on the third set of reference data and the second set of reference data.

4. The system of claim 3, wherein the one or more hardware processors are further configured by machine-readable instructions to:
generate the notification responsive to a smart contract executed on the blockchain detecting the third hash.

5. The system of claim 1, wherein the one or more hardware processors are further configured by machine-readable instructions to:
receive, from the first data processing system, a third set of reference data; and
determine the second hash based on the third set of reference data and the second set of reference data.

6. The system of claim 1, wherein the one or more hardware processors are further configured by machine-readable instructions to encrypt at least a portion of the third hash with a public key of the third data processing system.

7. A method to validate blockchain records in a networked environment, comprising:
receiving, from a first data processing system, a first set of reference data of an interaction with the first data processing system;
determining a first hash based on the first set of reference data and a first location on a blockchain;
posting the first hash to the blockchain at the first location;
receiving, from a second data processing system, a second set of reference data;
determining a second hash based on the second set of reference data and a second location on the blockchain;
posting the second hash to the blockchain at the second location;
generating a third hash based on a matching of the first hash with the second hash;
posting the third hash to the blockchain at a third location; and
transmitting a notification to a third data processing system based on detecting the third hash at the third location.

8. The method of claim 7, wherein the first set of reference data and the second set of reference data comprises at least one of an order number, a customer number, a tracking number, a date, an address, an exemption code, or a product code.

9. The method of claim 7, further comprising:
receiving, from a third data processing system, a third set of reference data; and
determining the second hash based on the third set of reference data and the second set of reference data.

10. The method of claim 9, further comprising:
generating the notification responsive to a smart contract executed on the blockchain detecting the third hash.

11. The method of claim 7, further comprising:
receiving, from the first data processing system, a third set of reference data; and
determining the second hash based on the third set of reference data and the second set of reference data.

12. The method of claim 7, further comprising encrypting at least a portion of the third hash with a public key of the third data processing system.

13. A non-transient computer-readable storage medium having instructions stored thereon, the instructions being executable by one or more processors to perform a method to validate blockchain records in a networked environment, the method comprising:
receiving, from a first data processing system, a first set of reference data of an interaction with the first data processing system;
determining a first hash based on the first set of reference data and a first location on a blockchain;
posting the first hash to the blockchain at the first location;
receiving, from a second data processing system, a second set of reference data;
determining a second hash based on the second set of reference data and a second location on the blockchain;
posting the second hash to the blockchain at the second location;
generating a third hash based on a matching of the first hash with the second hash;
posting the third hash to the blockchain at a third location; and
transmitting a notification to a third data processing system based on detecting the third hash at the third location.

14. The computer-readable storage medium of claim 13, wherein the first set of reference data and the second set of reference data comprises at least one of an order number, a customer number, a tracking number, a date, an address, an exemption code, or a product code.

15. The computer-readable storage medium of claim 13, wherein the method further comprises:
receiving, from a third data processing system, a third set of reference data; and
determining the second hash based on the third set of reference data and the second set of reference data.

16. The computer-readable storage medium of claim 15, wherein the method further comprises:
generating the notification responsive to a smart contract executed on the blockchain detecting the third hash.

17. The computer-readable storage medium of claim 13, wherein the method further comprises:
receiving, from the first data processing system, a third set of reference data; and
determining the second hash based on the third set of reference data and the second set of reference data.

18. The computer-readable storage medium of claim 13, wherein the method further comprises encrypting at least a portion of the third hash with a public key of the third data processing system.
